(19) United States
(12) Patent Application Publication
(10) Pub. No.: US 2011/0229865 A1
(43) Pub. Date: Sep. 22, 2011

(54) System and method for reducing heavy drinking

(76) Inventor: Reid Kevin Hester, Albuquerque, NM (US)

(21) Appl. No.: 12/661,337

(22) Filed: Mar. 16, 2010

(51) Int. Cl. G09B 19/00; G09B 7/00

(52) U.S. Cl. 434/236; 434/362

(57) ABSTRACT

The present invention relates to a system and method for motivating heavy drinking college students to reduce their drinking and alcohol-related problems by utilizing a computer-based software program to screen for heavy drinking and for those who screen positive, provide a comprehensive assessment of drinking and alcohol-related problems, provide personalized feedback to the user with relevant norms, assist users in resolving their ambivalence about changing, and help them develop a plan of action to achieve the goals of drinking less and having fewer alcohol-related problems. The method includes a way for University administrators to implement the system on a campus-wide basis, customize the system to their specific campus and its needs, manage the dataset, and generate outcome reports that measure pertinent clinical outcomes of the program.

### STATEMENT REGARDING FEDERALLY SPONSORED R&D

This invention was made with Government support under Small Business Innovative Research Grant 1 R44-AA014766 “A computer-based brief intervention for college students” awarded by the National Institute of Alcohol Abuse and Alcoholism of the National Institutes of Health. The Government has certain rights in the invention.

### BACKGROUND OF THE INVENTION

1. Field of the Invention

The present invention relates to a computer-based system and method that motivates heavy drinking college students to reduce their drinking and alcohol-related problems. It includes a cognitive-behavioral intervention for the students, a follow-up program that assesses changes in drinking and alcohol-related problems over time, and a module that enables program administrators to customize it to the college or university, manage the data set, and evaluate the clinical outcomes of the intervention via customized outcome reports.

2. Description of Prior Art

Heavy Drinking and Alcohol-Related Problems in College Students. In 1999 the National Institute of Alcohol Abuse and Alcoholism (NIAAA) created a Task Force on College Drinking in response to increasing public, congressional, and NIAAA concerns. NIAAA also emphasized the importance of research to provide evidence-based data to college administrators and other policy makers. The Task Force evaluated the extent of the problem, reviewed the literature in the area, and made recommendations to researchers and college personnel about how best to address the growing problem of college student drinking. A special supplement of the Journal of Studies on Alcohol (JSA) (March 2002) was devoted to these issues. The following is based on data from the JSA supplement, along with conclusions from the NIAAA Task Force final report.

Heavy drinking by college students is on the increase and alcohol-related problems among college students are significant. Hingson, Hereen, and Zakocs (2002) summarized results of national surveys of college drinking and mortality and morbidity. When heavy drinking was defined as 5 or more drinks/occasion for males and 4 or more for females, it was found that 40% of college students drank heavily at least once in the previous two weeks in 1999. Another survey found that the frequency of heavy drinking has increased from 1993 to 1999. Alcohol related problems are also a significant problem: Each year there are an estimated 1,400 deaths, 500,000 injuries, more than 600,000 assaults (by another student who's been drinking), 70,000 reported incidents of sexual assault or date rape, 400,000 incidents of unprotected sex, and more than 100,000 incidents of students being too intoxicated to know if they consented to sex (Hingson et al., 2002). Academic problems are also common. About 25% of college students report some alcohol related consequences from their drinking (e.g., missed classes, poor performance on exams, lower grades overall). More than 150,000 students develop alcohol-related health problems each year. Drunk driving, vandalism, and involvement with police or campus security are additional negative consequences.

In-line with the NIAAA Task Force efforts, Brown University's Center for Alcohol and Addiction Studies sponsored a conference in 2004 that focused on core aspects of college student substance abuse and treatment to open a dialogue on the issue between researchers and university-based treatment providers. Three core areas addressed at the conference included: alcohol and tobacco use, epidemiology, and co-morbidity; prevention and social norms approaches to college student drinking and smoking; and interventions for college student substance abuse. With respect to interventions, two clear messages emerged: first, there is sound, scientific evidence supporting the efficacy of brief interventions for alcohol abuse with young (college) adults; second, university-based treatment providers desperately want and need help to implement brief interventions.

Brief Interventions. There is growing evidence of the effectiveness of brief interventions with heavy drinking college students. In a brief intervention study conducted through the mail with no personal clinical contact, Agostinelli, Brown and Miller (1995) found that when students were mailed objective feedback about how their drinking compared to college-based norms they had significantly reduced their drinking at 6-week follow-up relative to controls who did not receive feedback. Walters (2000), and Walters, Bennett and Miller(2000), replicated Agostinelli's findings with college students and subsequently with working adults (Walters & Woodall, 2003). Collins, Carey and Sliwinski (2002) conducted a similar study with personalized mailed feedback and found those who received the feedback reduced their drinking at 6 weeks relative to an attention control group. Kypri, Saunders, Williams, McGee, Langley, Cashell-Smith and Gallagher (2004) found results similar to that of Collins and colleagues with a web-based intervention.

In related work, Dimeff (2000) randomly assigned heavy drinking students from a college health center to one of two groups. The experimental group received a computer-based assessment along with personalized feedback. Results were reviewed and discussed with the student by his or her primary care physician. The control group participated in assessments only and did not receive personalized feedback. At 4-week follow-up the experimental group demonstrated significant reductions in both drinking and alcohol-related problems. Reviewing these outcomes, Larimer and Cronce concluded that: “use of computer-generated feedback in a health care setting may be a viable option for prevention of alcohol misuse,” and that brief interventions and skills-training have the greatest evidence of effectiveness. Such approaches, in their view, are recommended for use with high risk student populations (2002, pg. 155).

Since the Larimer and Cronce review, Neighbors, Larimer and Lewis (2004) have developed and evaluated a computer-based, personalized normative feedback program. They found reduced drinking at 3 and 6 month follow-ups in a sample of heavy drinking college students.

Murphy, Benson, Vuchinich, Deskins, Eakin, Flood, McDevitt-Murphy, and Torrealday (2004) randomized students to receive a brief intervention with personalized feedback with or without an individual motivational interview. At a 6-month follow-up, participants in both groups showed mean reductions in drinking, with no differences between the groups. On average, participants reported drinking 5.19 drinks per week less than at baseline.

In a review of this literature, Walters and Neighbors (2005) found 13 published reports of controlled clinical trials of brief interventions that included personalized feedback. Of these, 11 found a significant reduction in drinking relative to a control or comparison group. Follow-ups ranged from 6 weeks to 24 months. In only two studies did significant effects found at early follow-ups not persist to the more distal follow-up. Four studies had follow-ups ranging from 9-24 months. Of these, three found significant differences in drinking out to the most distal follow-up.

U.S. Pat. No. 7,287,017 of Martin Pellinat published on Oct. 23, 2007 titled Decision engine, discloses a method for implementing a comparative or opportunity based decision making methodology. Another related patent is U.S. Pat. No. 6,439,893 of Jacqueline Byrd et al., published on Aug. 27, 2002, titled: Web based, on-line system and method for assessing, monitoring and modifying a given behavioral characteristic; which discloses a system and method for interactively assessing at least one characteristic of a user on-line, developing a personal growth strategy and monitoring the person's progress with respect to the personal growth strategy. A third related patent is U.S. Pat. No. 7,024,398 of Michael Kilgard et al., published on Apr. 4, 2006, titled: Computer-implemented methods and apparatus for alleviating abnormal behaviors; which discloses systems and methods for alleviating abnormal behavior. A fourth related patent is U.S. Pat. No. 737,376,700 B1 of Paul Clark et al., published on May 20, 2008, titled: Personal coaching system for clients with ongoing concerns such as weight loss; which discloses a system for coaching a number of clients that involves matching clients to coaches based on client input, and initiation of the coaching relationship with a set of recommendations also based on the client's input.

Deficiencies in existing programs. The patented programs just described are deficient in three ways. First, they do not specifically address substance use and alcohol-related problems which is necessary to motivate heavy drinking college students. Second, they do not address the issues of motivation for changing drinking. They are action-oriented systems and methods. Third, they do not provide personalized feedback about the user's drinking which is considered to be a crucial component of brief interventions with heavy drinking college students.

The more alcohol specific programs described in the paragraphs above the related patents, none of which are patented, are deficient in seven ways. First, while clinical trials of the programs demonstrate statistically significant reductions in drinking and alcohol-related problems, the clinical magnitude of these changes is modest. Programs with larger effects are needed. Second, the commercially available programs like the eCHUG (http://interwork.sdsu.edu/echug/index.html) and My Student Body (www.mystudentbody.com) lack the decision making and action planning components (described in the Description of the Invention section) which are crucial in assisting users who wish to make changes because they provide a structured format that organizes those changes. Third, the programs are structured in such a way that the companies sell them via annual subscription fees which present an economic barrier to their dissemination. Fourth, the existing programs lack the customizable features that college administrators could use to maximize the effectiveness of the intervention in their own domain. Fifth, the existing programs do not use university specific feedback based on the Core Institute's alcohol-related problems norms for a particular university. Sixth, the existing programs' outcome report functions are not under the sole control of the university but always under the control of the company selling the program to the university. Seventh, the existing programs are solely Internet-based and do not have the option to be used on a free standing computer with a database set up specifically for that computer and it's associated site at the university (e.g., student healthcare clinic). This invention addresses these deficiencies.

### SUMMARY OF THE INVENTION

The present invention is different than the prior art. The program is a brief motivational intervention that motivates heavy drinking college students to reduce their drinking and, as a result, their alcohol-related problems to a greater extent than the prior art because the therapeutic method contains elements of decision making and planning a course of action. The program is also structured in a way that allows those who purchase it significant flexibility in controlling how it is customized and used both by students and by administrators with an interest in the outcomes of the therapeutic method. It also uses university and gender specific Core Institute norms to assess and provide personalized feedback to the student on his or her alcohol-related problems

It is an object of the present invention to provide a system and methods that reduce heavy drinking among college students.

It is another object of the present invention to provide a system comprised of a computer and printer for students and administrators, and an Internet-based database. The methods provide a therapeutic intervention for students and a way for University administrators to manage the system, optimize it, and be able to evaluate the clinical outcomes of the intervention the students receive.

It is another object of the present invention to provide a therapeutic intervention for heavy drinking college students that comprises: a screening for heavy drinking with immediate feedback; a module that assesses the student's likes and dislikes about drinking; a module that assesses the student's family history of alcohol problems, age of onset of drinking, and history and current use of other drugs; a module that assesses the student's drinking and alcohol-related problems; a feedback module that provides personalized, clinically relevant feedback to the user about his or her drinking and alcohol-related problems relative to his or her University norms; a module that motivates the student to reduce his or her drinking and helps him or her develop a plan of action to accomplish that goal; and a follow-up component that allows users to re-access the method to track their progress over time.

It is another object of the present invention to provide a computer-based method for allowing an administrator of the system to manage and customize the design and implementation of a program for reducing drinking comprising the steps of: a module that allows administrators of the system to customize the visual presentation of the program to the student so that it is consistent with the University's logos and color schemes; a module that allows administrators of the system to enter University specific norms for drinking and alcohol-related problems; a module that allows administrators of the system to see and develop the database on those individuals who utilize the system; a module that allows administrators of the system to manage the system database so that it will provide information pertinent to the use or uses they deem necessary; a module that allows administrators of the system to enter local resources for additional clinical assistance for the users; a module that allows administrators of the system to create and display a list of frequently asked questions for the users; and a module that allows administrators of the system to generate clinically relevant outcome reports.

It is another object of the present invention to provide a system and methods that overcome the deficiencies of the prior art. With respect to the related patents, this invention specifically addresses heavy drinking and alcohol-related problems that the patented inventions do not. It also addresses the issues of motivation for change and provides personalized feedback which the related patents do not address. The present invention also addresses the deficiencies in the copyrighted programs described in the prior art. First, because the therapeutic intervention contains decisional balance exercises to enhance motivation and helps students who wish to make changes develop plans within a structured format that organizes those changes, it can have a clinically meaningful impact on heavy drinking in this population. Second, the invention, when licensed to a University, is under the sole control of that organization which allows the organization to maximize its effectiveness in an iterative manner. Third, the invention uses University specific feedback based on the Core Institute's alcohol-related problems norms which enhances its effectiveness. Fourth, the outcome report functions are controlled by the University. Fifth, the invention can be implemented as either a solely Internet-based program or a Windows-based program, or both. With the latter option, a University could set up the program specifically for a particular site with its own unique database.

### BRIEF DESCRIPTION OF THE DRAWINGS

FIG. 1 is a flow diagram of the best mode of the present invention that illustrates the interaction between the software program, the data set, the program administrator, and the student user.

FIG. 2 shows a flow diagram of the best mode of the present invention describing the method of the clinical intervention for the student from screening through to follow-up.

FIG. 3 shows a flow diagram of the best mode of the present invention describing the method of the administrative functions of the program.

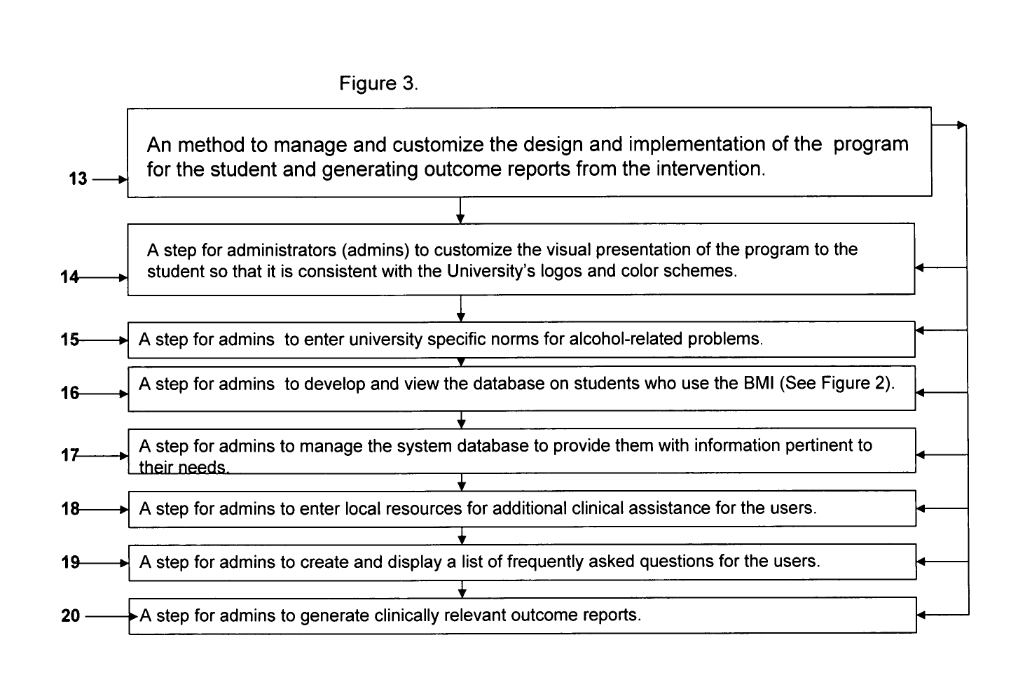

### DETAILED DESCRIPTION OF THE INVENTION

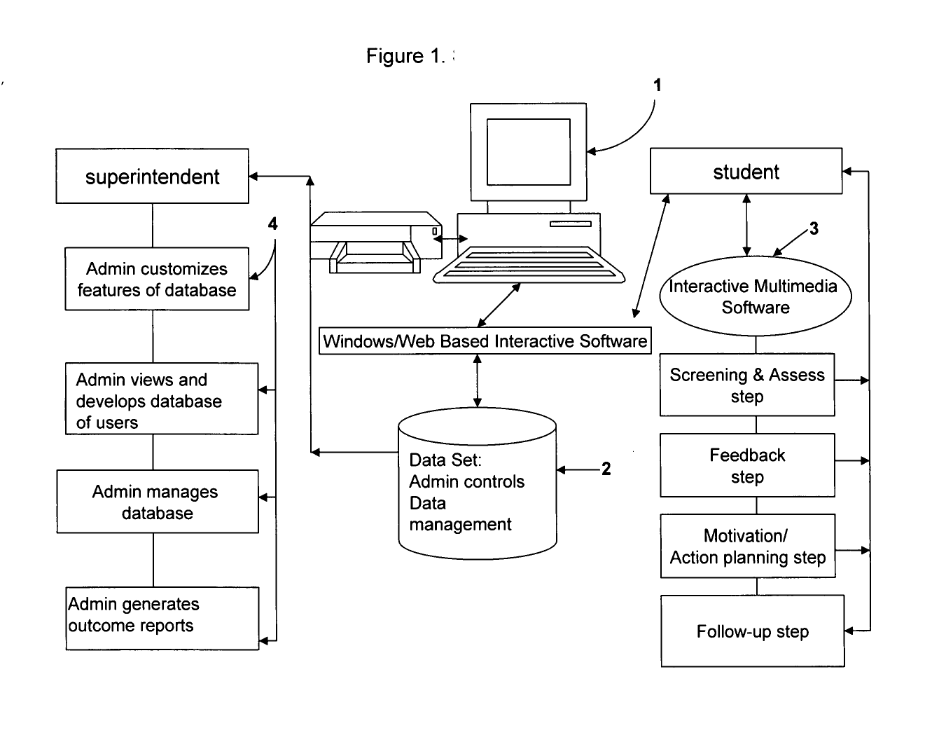

FIG. 1 shows a flow diagram of the best mode of the present invention's system. The system comprises a computer and printer for students' use, interactive software that provides a brief motivational intervention (BMI) to the student, an Internet-based relational database that collects and saves the input of the student and provides the basis for the individualized feedback and motivational enhancement modules of the software, and an administrator's software program that allows them to customize how the program appears to the student, which assessments are included in the BMI, acquisition and management of the database, and the ability to generate clinical outcome reports from the database.

In the best mode of the present invention the computer 1 used by the student is a Microsoft Windows machine if the Windows version of the program is used. If the solely Internet-based version of the invention is used, the computer can have any operating system as long as it has a web browser installed on it.

In the best mode of the present invention the computer 2 hosting the relational database on the Internet is a web server capable of running a Microsoft ASP.NET software application and a MySQL database.

In the best mode of the present invention the software program that provide the methods for achieving 3-4 for the student and for the administrator is a Microsoft ASP.NET program in either a Windows or web-based execution.

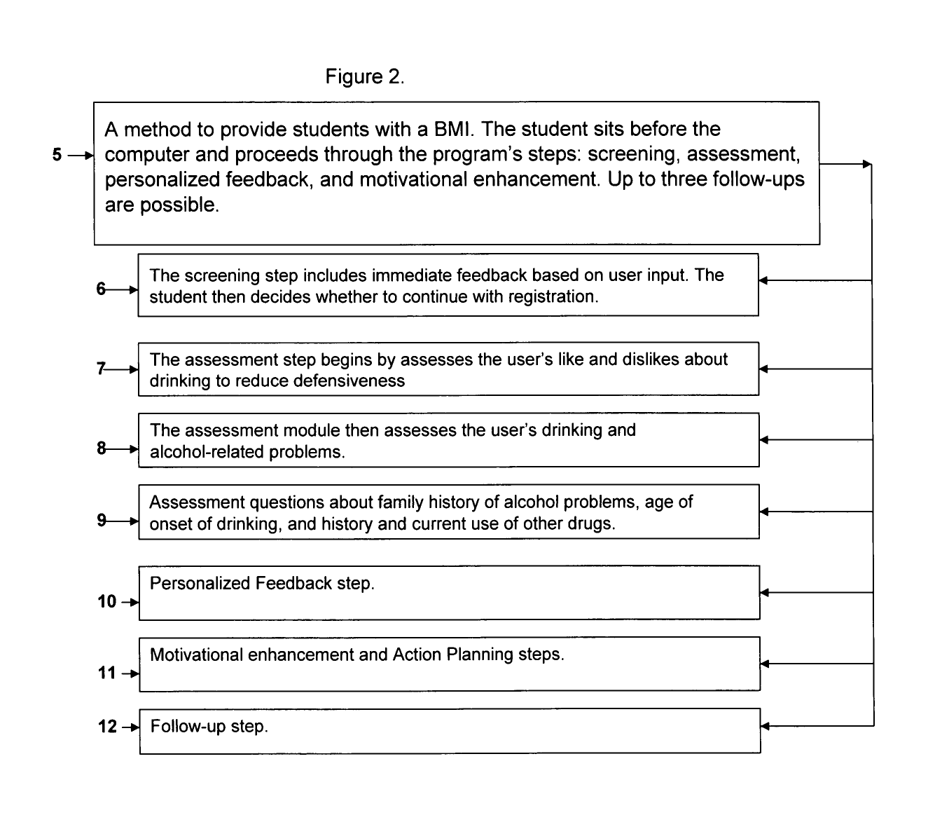

FIG. 2 shows a flow diagram of the best mode of the present invention's method for administering the therapeutic intervention (BMI) to the student.

The BMI begins when the student sits down at the computer 1 and sees a welcome screen 5 customized with the logo and color scheme of his or her university. At the top of the page are links for both new users and for students who have already registered to use the program. New users are invited to consider an overview of the program. What follows are then six screens that provide summary of the program with brief descriptions of the clinical modules “Look at Your Drinking,” “Get Feedback,” and “Consider Your Options.” The program then reduces students' potential resistance to change by noting that not everyone using the program makes changes right away; that some decide later to do so.

A screening questionnaire 6 that follows the overview is prefaced by an introduction which explains how the screening can help students determine whether or not the program might be useful for them. The screening questionnaire itself begins by asking the student about his or her heaviest drinking episode in the prior two weeks; the program presents a drop down list for number of drinks and a drop down list for the number of hours spent drinking those drinks on that occasion. The program then asks the student to indicate his or her gender and weight in either pounds or kilograms. The drinking episode questions are followed by a set of ten questions from the Alcohol User Disorders Identification Test (AUDIT; Babor et al., 1992).

Once the student has answered all the questions and clicked the Submit button on the screen, the program provides immediate feedback based on their answers. (If a question is not answered, an error message pops up indicating which question was not answered. When the student clicks the OK button, the pop up window disappears so that he or she can answer that question.) The student is then given feedback on the estimated peak blood alcohol concentration (BAC) during his or her drinking episode. Male students who drank 5 or more drinks (4 or more for women) on the occasion and/or attained an estimated peak BAC of 80 mg % are advised to register and use the program. Students are also given feedback based on their AUDIT score, which rates the relative severity of the drinking related problems in their lives (ranging from low, medium, high, or very high). Those who score 8 or higher are also advised to register and use the program.

Students who decide to go through the program are invited to register at this point, and are then taken back to the homepage and three pop-up animated links that lead to the three main modules: Look at Your Drinking (the assessment module), Get Feedback (the clinical feedback module), and Decide What To Do (the decision making and change planning module).

The first module, Look at Your Drinking 7, begins with an initial decisional balance exercise weighing the “good things” and “not so good things” about drinking. This exercise is followed by the Brief Drinker's Profile (BDP) (Miller & Marlatt, 1987), which asks the students about their typical drinking patterns 8, family history of alcohol problems, age of onset of drinking, and history and current use of other drugs 9. The BDP is followed by the College Students' Alcohol Problems (CSAP) section from the Core Institute's annual survey of drinking, drug use, and related problems. The initial decisional balance exercise 7 and the subsequent decisional balance exercise in the Decision Making module (discussed below) are included because research in natural recovery from alcohol and drug problems suggests that weighing the pros and cons of changing is both a common and important process that people use to help them decide to change their drinking (Sobell et al., 2001).

In the Look at Your Drinking module, the user can take the assessment instruments in any sequence he or she wishes. The status of which questionnaires have been completed is noted by a check mark to the left of each. This is one example of how we have designed the functionality of the program to allow students choices in how they interact with the program. As students proceed through all three CDCU modules they have the opportunity to go backwards or forwards in the modules. This also allows them to change responses, if necessary.

The Get Feedback module 10 provides personalized feedback on the student's quantity/frequency of drinking with respect to total amount and estimated peak blood alcohol concentrations (BACs) relative to the population of U.S. adults (and specific to the drinker's gender); how their quantity of drinking compares to other students of their own gender at their own university (based on Core Institute data that each University receives annually); how often they've had 5 or more drinks in the last month (4 or more for women) and how this compares to other university students of their same gender; how many calories they consume in drinking per month (using a latte coffee drink as a unit of reference) how much money they spend per year drinking based on their estimate of their monthly expenditure and (optionally, depending on therapist input) what percent this is of some popular item on campus (e.g., iPod); level of tolerance based on the student's maximum estimated BAC (it also explains tolerance as a risk factor for further alcohol-related problems); the student's levels of risk factors (from the BDP) for further alcohol-related problems (e.g., family history, other drug use); and how the student's alcohol-related consequences compare to other students of their own gender at their university (based on their responses to the CSAP questionnaire).

The Consider Your Options module 11 involves decision making and change planning that includes subtle advice to on how to change as well as a menu of elements designed to help students make well-reasoned decisions about a possible change in their drinking. Elements include a “Readiness Ruler” to gauge the student's current readiness to change his or her drinking) (Rollnick et al., 1999); and a second decisional balance exercise that includes data from the first such exercise (in the Assessment module) and further asks the student to incorporate any new thoughts or additional information they have based on his or her feedback.

The student is then asked to do a functional analysis of their drinking (Miller & Sanchez, 1994); a Change Plan (taken from Project MATCH's MET protocol, Project MATCH, 1994); and is given self-help, mutual help, Internet, university-specific, and professional resources to help the him or her achieve his or her goals. The BMI finishes with a summary of their feedback then presents a Certificate of Completion for the student to print out.

Students also have the ability to print any particular screen from the CDCU program. In addition, the program automatically prints a copy of the feedback summary, change plan, decisional balance exercises, functional analysis of their drinking, and the personal BAC table when users complete the program. Students can also view and print a feedback summary from the navigation icons on the program's menu.

Students who return to the program after their first use 12 will be asked to log on; they will then be asked to select their appropriate follow-up session. Once they have done so, they will be invited to go to the Look at Your Drinking module and enter their drinking data as they did on prior sessions. Once students have entered their drinking data, the program will provide them with a feedback summary, which allows them to compare their prior drinking data to the data they just entered.

Administrators of the system use their control functions to establish whether students will undertake 1, 2 or 3 follow-up sessions, and also to determine how much time passes between the follow-up sessions.

In the best mode of the present invention the Administrator's program is password protected program and enables an administrator (admin) of the program 13 to perform the following functions: customizing the visual presentation of the BMI program to the student so that it is consistent with the University's logos and color schemes 14; entering their University specific norms for drinking and alcohol-related problems 15; see the database of those individuals who utilize the system 16; manage the system database so that it will provide information pertinent to the use or uses they deem necessary 17; enter local resources for additional clinical assistance for the users 18; create and display a list of frequently asked questions for the users 19; and generate clinically relevant outcome reports 20.

In the best mode of the present invention the features of the admin's program are visually presented on a single form or page on the screen with labeled tabs across the top for the functions of the program: The default tab that is displayed first is labeled “Demographics” 16. That section of the page displays a scrolling list of students in the database, with the option to view and revise a particular student's demographic data, insert new students into the database, delete students from the database, logon for a student, create up to four custom fields for the database (e.g., group, study number, etc. . . . ), enter a study ID if the student is in a clinical study of the therapeutic intervention, change the admin password, and begin the process of generating outcome reports.

The second tab 16, labeled “Drink Data,” displays baseline assessment data on drinking when a particular student is selected in the previous tab.

The third tab 15, labeled “Feedback2,” displays baseline assessment data on alcohol-related problems when a particular student is selected in the previous tab.

The fourth tab 17, labeled “Tests/Follow-ups,” allows the admin to specify which of the assessment instruments are given at baseline and up to three follow-up points. The time from baseline at each follow-up is also specifiable. This tab also has a feature that, when checked, provides students with outcome reports that compare their baseline assessment to their follow-up assessment(s) after they've completed a follow-up.

The fifth tab 14, labeled “Name, Logo, Norms,” lets the admin specify the school's name, year of norms for which feedback is based on, the school's logo in graphic format (e.g., jpg, gif), the school colors (up to 2), and drinking data from the Core Institute's survey of their University's students. These data are the average number of drinks per week for males, females, and the total sample and the percentiles for how often students have 5 or more drinks in one setting. The tab also allows automatic printing of reports both for the admin's outcome reports and for the student when he or she is using the BMI.

The sixth tab 15, labeled “Core Norms (2),” lets the admin enter the percentiles for the average number of drinks students consume per week for males, females, and the total sample in a scrolling table which can be printed out for verification of the data entered. It also lets the admin enter an item that students like to have (e.g., iPhone) and the typical cost of that item. If this data is entered, the program uses it in the BMI feedback section to compare the student's annual expenditures on alcohol with this item.

The sixth tab 15, labeled “Core Norms (3),” lets the admin enter the percentiles for each frequency of each alcohol-related problem in the Core Institute survey. Universities that use the Core Institute to survey drinking and alcohol-related problems in their student population have these data provided by the Core Institute annually.

The seventh tab, labeled “FAQ/ASK/Resources,” lets the admin enter a list of frequently asked questions 19 (FAQs) and answers, local resources for additional clinical assistance for the students 18, and to specify what email server and email address questions that students have about the program are sent via and to.

In the best mode of the present invention the outcome reports 20 function is launched by clicking a button on the Demographics tab of the Admin program. This brings up a pop up window that describes the report options: individual client reports; total sample reports (by date ranges); and a comparison of two groups. It also describes the summary data as sample sizes, means and standard deviations.

When the admin clicks the Next button the report options appear on the screen: report for an individual; report for the total sample; and customized group reports. The group reports feature allows the admin to create 2 custom groups from the database. Groups can be created with the following variables: gender; age, ethnicity, year in school; residential status; academic status (full or part-time); greek status; varsity status, mandated (because of alcohol policy violations); and the 4 custom fields that can be specified in the Demographics tab.

If a report for the total sample button is clicked the program then asks for a date range for the baseline assessments and the earliest and most recent dates are displayed. The admin then enters a desired date range and clicks the next button.

If a report without respect to a date range is desired the admin clicks the next button with the default dates the program has entered. If the admin clicks the button for a report on an individual, the next form displays a scrolling list of students listed in ascending order by their database ID and usernames.

Once the desired outcome report is generated, the admin can view it on the screen, print out a hard copy, and export the report as either an Excel spreadsheet or a pdf file.

What is claimed is:

1. A computer-based system that reduces alcohol consumption among college students comprising: a computing system able to run at a rate of at least one gigahertz; a program that runs a therapeutic intervention for concomitant individual and organizational use that will be able to run on said computing system; a data set to run on said computing system running said program; and device to obtain the output of a run of a data set so as to properly interface with the human subject.

2. A computer-based system as set forth in claim 1 further comprised of Windows or web-based compatible software to coordinate, implement and manage all components of the program.

3. A computer-based system as set forth in claim 1 further comprised of a module containing a therapeutic intervention.

4. A computer-based system as set forth in claim 1 further comprised of a module containing administrative controls and database management of the system.

5. An interactive, multi-media method to help heavy-drinking college students reduce their alcohol consumption comprising the steps of: having the student take a screening questionnaire; using a module to assess the user's likes and dislikes about drinking; using a module to assess the user's drinking and alcohol-related problems; using a module to assess the user's family history of alcohol problems, age of onset of drinking, and history and current use of other drugs; employing a feedback module to provide personalized, clinically relevant feedback to the user about his or her drinking and alcohol-related problems; using a module to motivate the user to reduce his or her drinking and helps them develop a plan of action to accomplish that goal; and employing a follow-up component that allows the user to re-access the method to track their progress over time.

6. An interactive, multi-media method as set forth in claim 5 further comprising the step of: employing a screening questionnaire to obtain a data set to run.

7. An interactive, multi-media method as set forth in claim 5 further comprising the step of: employing a module to assess the user's likes and dislikes about drinking.

8. An interactive, multi-media method as set forth in claim 5 further comprising the step of: employing a module to assess the user's drinking and alcohol-related problems.

9. An interactive, multi-media method as set forth in claim 5 further comprising the step of: employing a module to assess the user's family history of alcohol problems, age of onset of drinking, and history and current use of other drugs.

10. An interactive, multi-media method as set forth in claim 5 further comprising the step of: employing a feedback module to provide personalized, clinically relevant feedback to the user about his or her drinking and alcohol-related problems.

11. An interactive, multi-media method as set forth in claim 5 further comprising the step of: employing a module to motivate the user of the method to reduce his or her drinking and helps them develop a plan of action to accomplish that goal.

12. An interactive, multi-media method as set forth in claim 5 further comprising the step of: employing a follow-up component to allow the user to re-access the method to track their progress over time.

13. A computer-based method for allowing an administrator of the system to manage and customize the design and implementation of a program for reducing drinking comprising the steps of: employing a module that allows administrators of the system to customize the visual presentation of the program to the student so that it is consistent with the University's logos and color schemes; employing a module to allow administrators of the system to enter University specific norms for drinking and alcohol-related problems; employing a module to allow administrators of the system to see the database on those individuals who utilize the system; employing a module that allows administrators of the system to manage the system database so that it will provide information pertinent to the use or uses they deem necessary; employing a module to allow administrators of the system to enter local resources for additional clinical assistance for the users; employing a module to allow administrators of the system to create and display a list of frequently asked questions for the users; and using a module to allow administrators of the system to generate clinically relevant outcome reports.

14. A computer-based method as set forth in claim 13 further comprising the step of: employing a module to allow administrators of the system to customize the visual presentation of the program to the student so that it is consistent with the University's logos and color schemes.

15. A computer-based method as set forth in claim 13 further comprising the step of: employing a module to allow administrators of the system to enter University specific norms for drinking and alcohol-related problems.

16. A computer-based method as set forth in claim 13 further comprising the step of: employing a module to allow administrators of the system to see and develop the database on those individuals who utilize the system.

17. A computer-based method as set forth in claim 13 further comprising the step of: employing a module to allow administrators of the system to manage the system database so that it will provide information pertinent to the use or uses they deem necessary.

18. A computer-based method as set forth in claim 13 further comprising the step of: employing a module to allow administrators of the system to enter local resources for additional clinical assistance for the users;

19. A computer-based method as set forth in claim 13 further comprising the step of: employing a module to allow administrators of the system to create and display a list of frequently asked questions for the users

20. A computer-based method as set forth in claim 13 further comprising the step of: employing a module to allow administrators of the system to generate clinically relevant outcome reports.
